(19) United States
(12) Patent Application Publication
(10) Pub. No.: US 2010/0104122 A1
(43) Pub. Date: Apr. 29, 2010

(54) METHOD FOR ESTABLISHING PERFORMANCE OF HEARING DEVICES

(75) Inventor: Bernd Waldmann, Maur (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 12/593,374

(22) PCT Filed: Mar. 30, 2007
(86) PCT No.: PCT/EP07/53069

§ 371 Date: Sep. 28, 2009

(51) Int. Cl. H04R 25/00

(52) U.S. Cl. 381/314

(57) ABSTRACT

A method for establishing a performance characteristic of a hearing device (8, . . . , 11) is described. The method comprising the steps of collecting data in relation to the hearing device (8, . . . , 11) and/or its user, identifying characteristics of the hearing device (8, . . . , 11) and/or its user via at least a part of the collected data, providing a data base (2) comprising data of other hearing devices and/or its users, determining a set of data from the data base (2) on the basis of the identified characteristics, establishing a relation of at least a part of the collected data to the set of data from the data base (2), and establishing the performance characteristic from said relation.

### FIELD OF THE INVENTION

The present invention is related to a method for establishing a performance characteristic of a hearing device.

### BACKGROUND OF THE INVENTION

Presently used hearing devices are regularly maintained by an audiologist in that adjustments are made according to the experience made by the hearing device user while using his hearing device. A means for improving an adjustment cycle may be the use of well-known data logging capabilities. Therewith, the information of the hearing device user can be augmented by logging data that are very useful for reconstructing certain acoustic situations the hearing device user is confronted with, or for reconstructing patterns of use of the hearing device or specific features thereof by its user. This in turn opens up the possibility to even more accurately improve the adjustments of a hearing device.

A hearing device with data logging capabilities is disclosed in US-A1-2004/0190739 in the form of a multi-hearing program digitally programmable hearing device that comprises a data logging circuitry. The data logging circuitry is utilized to record a history of user-selectable events such as changes between different hearing programs or changes between different signal processing strategies. The user-selectable events can be freely adjusted or programmed, respectively. The known teaching is used to improve the adjustments made in the hearing device in order to improve the operation and the acceptability of the hearing device.

For adjusting or readjusting a hearing device, the audiologist may collect all information and/or data by either consulting the former adjustments stored for this hearing device in his computer, or he may download the former adjustments from the hearing device itself, if this feature is available for the corresponding hearing device. In addition, in case the hearing device has data logging capabilities, the logged data may also be downloaded and analyzed on the audiologist's computer. After this analysis, the audiologist uploads the new adjustments to the hearing device, and the hearing device user may inspect his hearing device with the new settings.

While adjusting or readjusting a hearing device, the audiologist is limited to his own experience collected during the adjustment of equal or similar hearing devices and of users having similar hearing impairments. As a consequence, the quality of an adjustment or a readjustment of a hearing device is limited by the audiologist's experience. In addition, the hearing device user himself has no means to check whether the audiologist has made a good adjustment, and, furthermore, the hearing device user does not know what he can expect of using his hearing device.

It is therefore one object of the present invention to improve the adjustment of hearing devices.

### SUMMARY OF THE INVENTION

A method for establishing a performance characteristic of a hearing device is described. The method comprising the steps of:
collecting data in relation to the hearing device and/or its user,
identifying characteristics of the hearing device and/or its user via at least a part of the collected data,
providing a data base comprising data of other hearing devices and/or its users,
determining a set of data from the data base on the basis of the identified characteristics,
establishing a relation of at least a part of the collected data to the set of data from the data base, and
establishing the performance characteristic from said relation.

Therewith, a counseling tool is provided for the audiologist who can improve and sustain the quality of his work. This is in particular the case if the audiologist is not experienced.

An embodiment of the present invention is characterized by further comprising the step of comparing the performance characteristic to a value calculated from the data of other hearing devices and/or its users.

Another embodiment of the present invention is characterized in that the step of establishing said relation is implemented by applying statistical calculations, in particular a calculation of a mean value.

A further embodiment of the present invention is characterized in that the data base comprises audiological data and that said relation is established by comparing the audiological data, or processed audiological data, stored in the data base to audiological data of the user of the hearing device.

The processed audiological data may be a statistical analysis and/or evaluation of audiological data of several patients or hearing device users.

A yet further embodiment of the present invention is characterized by further comprising the step of adjusting the hearing device based on the established performance characteristic.

A further embodiment of the present invention is characterized in that the performance characteristic can be one or more of the following:
performance of the hearing device, e.g. battery life time;
characteristics of the user, e.g. wearing duration;
adjustments of the hearing device, e.g. gain;
characteristics of the environment, e.g. the hearing device is in noisy surroundings for 30% of its operating time;
subjective assessment of benefit for the hearing device user, e.g. established via a questionnaire using GHABP or “Glasgow Hearing Aid Benefit Profile”;
audiological measurement of benefit for the hearing device user, e.g. by using a language test.

A further embodiment of the present invention is characterized in that the step of collecting data is implemented by logging data during operation of the hearing device.

A further embodiment of the present invention is characterized by storing the data in a local memory unit in the hearing device.

A further embodiment of the present invention is characterized by further comprising the step of uploading the collected data of the hearing device and/or its user to a processing unit.

A further embodiment of the present invention is characterized in that the processing unit accesses the data base via a network that is in particular the internet.

A further embodiment of the present invention is characterized in that the processing unit is incorporated into a portable device that is, for example, a mobile phone, a PDA or the like.

A further embodiment of the present invention is characterized in that the collected data only contain encrypted user information. Thereby, privacy of the individual hearing device user is guaranteed in that personal data is protected from unauthorized access by third parties. This includes the protection of knowledge of the audiologist that adjusted the hearing device. In particular, this knowledge may not be accessed by other audiologists.

A further embodiment of the present invention is characterized in that a tag is associated with the hearing device user and that the tag is used to identify the collected data of the corresponding user, wherein the tag only contains encrypted user information.

### BRIEF DESCRIPTION OF THE DRAWINGS

FIG. 1 schematically shows a block diagram of a network structure comprising hearing devices, and

FIG. 2 shows a histogram representing usages of hearing devices by its users in hours per day.

### DETAILED DESCRIPTION OF THE INVENTION

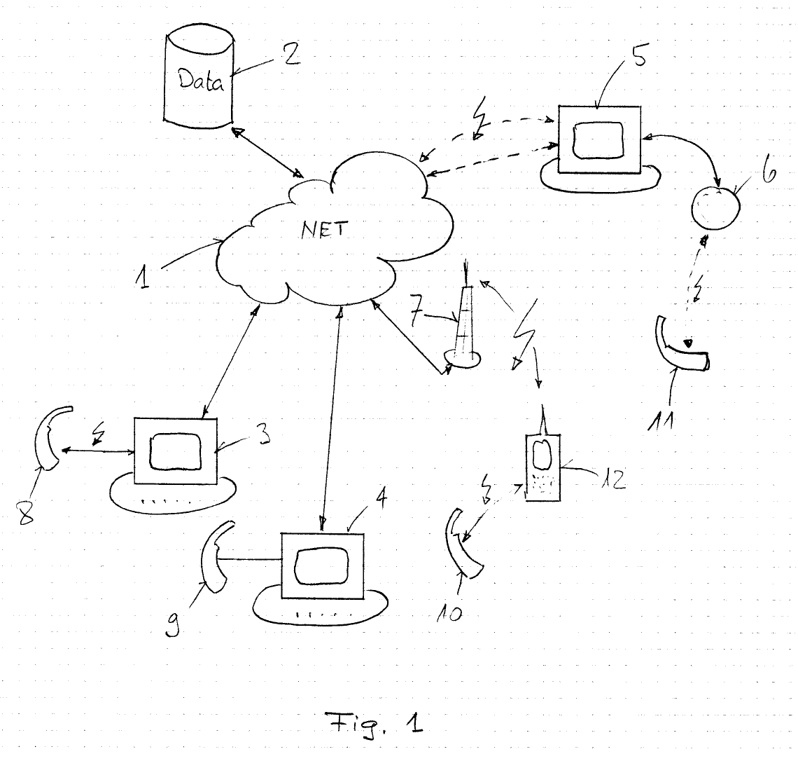

In FIG. 1, a block diagram of a network structure is depicted which may be used for implementing embodiments of the present invention. The network structure comprises a network 1, which is, for example, the internet, a data storage unit 2, several processing units 3 to 5 that are connected to the data storage unit 2 via the network 1, and hearing devices 8 to 11. The hearing devices 8 and 9 are connected to the processing units 3 and 4, respectively, the connection being either wired or wireless. In FIG. 1, the wireless connection is indicated by a flash sign in-between the processing unit 3 and the hearing device 8.

The connection between a hearing device and a processing unit may also be implemented via an intermediate unit. This is shown in FIG. 1 by an intermediate unit 6 arranged in-between the hearing device 11 and the processing unit 5. For example, an intermediate unit 6 is proposed for processing units 5 which do not incorporate wireless transmission facilities and therefore are in need of an external unit that provides these facilities in order to address the hearing device 11 having wireless transmission facilities only. The wireless transmission facilities can be realized according to a well-known standard, as for example the Bluetooth standard or the like. For a short range transmission, i.e. up to 15 cm, a transmission via magnetic induction can also be used. Many hearing devices available today allow charging or recharging its batteries via magnetic induction with the aid of a coupling device that is connected to a power line via an AC/DC-converter. For the purpose of data gathering in the processing unit 5, the coupling device, hereinafter called intermediate device 6, is also connected to processing unit 5 via a wired or wireless connection. Besides charging the battery, the intermediate device 6 is also used to read-out data, which has been recorded to a memory unit, for example a non-volatile memory unit, incorporated in the hearing device housing. The data being recorded during operation of the hearing device and now being read-out is transferred to the processing unit 5 where it is stored and/or further processed.

In another example, a hearing device is connected to a portable device such as a mobile telephone or a PDA-(Personal Digital Assistance). This is shown in FIG. 1 by the hearing device 10, which is wirelessly connected to a mobile telephone 12 that is in turn connected to the data storage unit 2 via a base antenna 7 and the network 2. The wireless connection between the mobile telephone 12 and the base antenna 7 is governed by well-known cellular telephone system standards, as for example the GSM system. On the other hand, the wireless connection between the hearing device 10 and the mobile telephone 12 can again be governed according to the Bluetooth-standard or other similar standards.

The above-described structure forms a basis for an implementation of methods according to the present invention, which will be described in the following:

Hearing devices, which are capable to log data in the meaning of what has been described in US-2004/0190739 A1 (which is herewith incorporated by reference in its entirety), transmit its data or further processed data to the data storage unit 2. On demand or automatically, the data of a user's hearing device are compared and a result of this comparison is transmitted back to the hearing device user or the audiologist for further processing or for review.

By providing the hearing device user and/or the audiologist with means to assess individual information or data related to usage, benefit or performance of a hearing device, a comparison can be performed to other hearing device users or their hearing devices.

The present invention allows to create statistical summaries of parameters related to hearing device use, benefit and performance, and to present those summaries together with the corresponding individual parameters to a hearing device user or to an audiologist or hearing care professional.

The present invention enables hearing device users and audiologists to evaluate the usage pattern, hearing device performance and benefit in comparison to other hearing device users. A high number of applications can be implemented by interpreting the result of the comparison. These are, for example:
technical troubleshooting, e.g. detecting unusually low battery life;
re-calibrating unrealistic expectations regarding hearing device benefit by demonstrating the range of benefit achieved by other users of the same or similar hearing devices;
using positive peer pressure to increase compliance with accepted best practices of hearing device use, e.g. with regard to daily usage time.

As has been mentioned-above, the present invention comprises hearing devices, optionally with data logging capabilities, and a personal computing device with access to the internet or an office computer with access to a database that holds records for multiple patients or hearing device users, respectively. Both the personal computing device and the office computer are called processing units throughout this description.

The processing unit can be or can be incorporated into, for example:
a portable or a desktop PC-(Personal Computer);
a portable PDA-(Personal Digital Assistants) or a pocket computers;
a programmable mobile phones, also called Smartphone;
a programmable personal audio devices, such as iPod of Apple, Inc.;
a programmable home entertainment device, such as a so-called set-top box.

Each of the above-mentioned devices may either have a direct connection to the network, or a connection to a personal computer or mobile phone, which in turn connects to the network.

The parameters related to hearing device use and performance collected via data logging (also called “performance characteristics”) include, for example:
battery life;
duration of daily use of the hearing device;
number of user controlled events, such as volume control changes or program changes, per unit of time;
information about the acoustic environment, such as percentage of total use time spent in a noisy environment, or on the telephone;

These parameters are collected by the hearing device in daily use, and can be downloaded to at least one of the hearing device user's processing unit, or an audiologist's processing unit.

Additional performance characteristics related to the use of hearing devices and to benefit include, for example:
gain of the hearing device amplifier, relative to the hearing loss, per frequency and input level;
score in questionnaires or other means for subjective assessment of hearing handicap, before and after deployment of a hearing device;
score in questionnaires or other means for subjective assessment of benefit;
score in speech tests or other objective means for determining hearing performance, before and after deployment of a hearing device.

It has already been pointed out that the audiologist has already collected some of these performance characteristics and stored in a database associated with personal information of a hearing device user, but no analyses has taken into account any data of other hearing device users.

In one embodiment of the present invention, some or all of the performance characteristics listed above are uploaded as datasets from the hearing device user's processing unit or from the audiologist's processing unit to a data storage unit 2 (FIG. 1), in which the uploaded datasets are combined for statistical analysis. The results of the analysis are transmitted back to the processing unit of the hearing device user or the processing units of the audiologist, respectively.

In another embodiment of the present invention, some or all of the performance characteristics listed above are stored in the processing unit in a manner that does not allows a link from the usage or performance data back to the personal information of the hearing device user. Therewith, software applications for hearing device fitting or counseling and sales support, possibly running on the processing units, can perform a statistical analysis of the usage and performance parameters from a large number of hearing device users without having to access personal records of individual hearing device users. Therewith, the confidentiality requirements are fulfilled.

The data uploaded to the data storage unit or to the database on the processing unit can be described by a tag that is unique for a hearing device user, such that all uploaded records for the same user can be grouped together. The tag can be derived from personal information in a way that makes it practically impossible to reverse the operation, i.e. to locate the user's personal information based on the tag, e.g. by using asymmetrical encryption algorithms well known in the art.

The following examples are presented to further explain the present invention:

In one example, a so-called “daily usage” service is provided, by which the duration of daily use of a hearing device is logged by the hearing device for a period of at least a week, for example. At the end of the week, the hearing device user uses his mobile telephone, for example, to run a community data logging software application. This application reads the logged data related to daily use from the hearing device and uploads it to the data storage unit, using internet connectivity built into the mobile telephone. The data storage unit, which in many instances does not only comprise means for storing data but also means for processing the data before or after storing it, responds with information about the statistical distribution of daily usage time for all subscribers of this service.

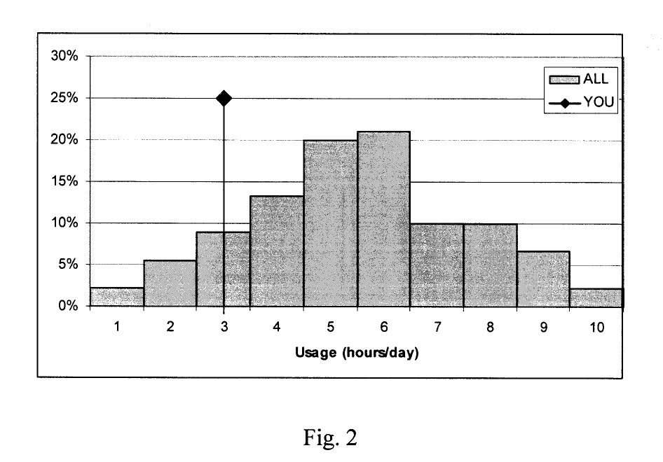

FIG. 2 shows a histogram for a user using his hearing device during three hours a day (indicated by “YOU” in FIG. 2) to illustrate this. The histogram is based on data entries for all other users having subscribed to this service. These users are identified by “ALL” in FIG. 2. The individual user can immediately compare this performance characteristic (here his daily usage) to the hearing device users having subscribed to this service.

The mobile telephone combines the statistical information from the data storage unit and the individual information from this user's hearing device, and displays a message such as, for example,

“You use your hearing device for 5.5 hours/day. On average, other users using the same hearing device model use it for 8 hours/day. 72% of all users of this hearing device use it for a longer time every day than you do. This statement is based on an analysis of 1325 users using the same hearing device model.”

In another example, an audiologist who works for a large chain of hearing device dispensers performs a speech test for a hearing device user. The audiologist uses a dedicated software application or office management software to store data comprising test results, a classification of the user's hearing impairment, such as “mild”, “moderate” or “severe”, and the hearing device model. This data is entered into the database maintained by the hearing device dispenser chain, along with other demographic and diagnostic information for that particular user. The dedicated software application or the office management software also sends an anonymized version of said data to a statistical analysis application, which may be local (i.e. on the processing unit of the audiologist) or on a data storage unit controlled by the hearing device dispenser chain.

The data storage unit responds with information about the statistical distribution of performance with the same speech test, for all other hearing device users whose data was submitted to the data storage unit, and whose degree of hearing impairment and hearing device model match the current user.

The dedicated software application or office management system then combines the statistical information from the data storage unit and the individual test performance of this user. A message is displayed, for example of the following type:

“You can understand 50% of the test words at 55 dB SPL. On average, users with your degree of hearing impairment and your hearing device model require 62 dB SPL to understand 50% of the words. Only 15% of all comparable users perform better than you. This statement is based on an analysis of 325 users with your degree of hearing loss and your hearing device model.”

The audiologist uses this message to counsel the user, and to have objective evidence for the above-average performance of the current user.

In another example, the hearing device logs the percentage of time a certain new signal processing feature is activated in the hearing device. During a follow up appointment, the audiologist uses fitting software to read the data logging information from the hearing device, and notices that the new signal processing feature was only used 10% of the time. The audiologist has not received extensive training regarding this new signal processing feature, so he cannot decide whether the low percentage is normal, or an indication of a device malfunction, or an indication of inappropriate use by the user. The audiologist therefore selects a “compare to others” function in the fitting software. Therefore, the fitting software uploads the logged information regarding use of the new signal processing feature to the data storage unit, without disclosing any personal information about the user, and the data storage unit responds with information about the statistical distribution of use of the new signal processing feature by all other users using the same hearing device model. The fitting software combines the statistical information from the data storage unit and the individual data of this user, and displays a message, for example as follows:

“In this hearing device, feature X was activated 10% of the time. On average, all other hearing devices of the same model had feature X activated 12% of the time. The activation in this hearing device is not statistically different from the average activation in all other hearing devices.”

The audiologist concludes that the observed activation pattern is normal, and makes no attempt to claim a malfunctioning device, or seek further assistance form the manufacturer.

Having thus shown and described what is at present considered as embodiments of the present invention, it should be noted that the same has been made by way of illustration and not limitations. Accordingly, all modifications, alterations and changes coming within the spirit and scope of the invention are herein meant to be included.

What is claimed is:

1. A method for establishing a performance characteristic of a hearing device, the method comprising the steps of:
collecting data in relation to the hearing device and/or its user,
identifying characteristics of the hearing device and/or its user via at least a part of the collected data,
providing a data base comprising data of other hearing devices and/or its users,
determining a set of data from the database on the basis of the identified characteristics,
establishing a relation of at least a part of the collected data to the set of data from the data base, and
establishing the performance characteristic from said relation.

2. The method of claim 1, characterized by further comprising the step of comparing the performance characteristic to a value calculated from the data of other hearing devices and/or its users.

3. The method of claim 1, characterized in that the step of establishing said relation is implemented by applying statistical calculations, in particular a calculation of a mean value.

4. The method of claim 1, characterized in that the data base comprises audiological data and that said relation is established by comparing the audiological data, or processed audiological data, stored in the data base to audiological data of the user of the hearing device.

5. The method of claim 1, characterized by further comprising the step of adjusting the hearing device based on the established performance characteristic.

6. The method of claim 1, characterized in that the performance characteristic can be one or more of the following:
performance of the hearing device, e.g. battery life time;
characteristics of the user, e.g. wearing duration;
adjustments of the hearing device, e.g. gain;
characteristics of the environment, e.g. a certain percentage in noisy surroundings;
subjective assessment of benefit for the hearing device user;
audiological measurement of benefit for the hearing device user.

7. The method of claim 1, characterized in that the step of collecting data is implemented by logging data during operation of the hearing device.

8. The method of claim 7, characterized by storing the data in a local memory unit in the hearing device.

9. The method of claim 1, characterized by further comprising the step of uploading the collected data of the hearing device and/or its user to a processing unit.

10. The method of claim 9, characterized in that the processing unit accesses the data base via a network that is in particular the internet.

11. The method of claim 9, characterized in that the processing unit is incorporated into a portable device that is, for example, a mobile phone, a PDA, a portable media player or the like.

12. The method of claim 1, characterized in that the collected data only contain encrypted user information.

13. The method of claim 1, characterized in that a tag is associated with the hearing device user and that the tag is used to identify the collected data of the corresponding user, wherein the tag only contains encrypted user information.
